(19) United States
(12) Patent Application Publication
(10) Pub. No.: US 2026/0084661 A1
(43) Pub. Date: Mar. 26, 2026

(54) Vehicle Stabilizers

(71) Applicant: MORRYDE INTERNATIONAL, INC., Elkhart, IN (US)

(72) Inventors: Michael Caster, Elkhart, IN (US); Ryan Mason, Niles, MI (US); Allen Roberts, Midland City, AL (US)

(21) Appl. No.: 19/337,174

(22) Filed: Sep. 23, 2025

Related U.S. Application Data
(60) Provisional application No. 63/698,303, filed on Sep. 24, 2024.

(51) Int. Cl. B60S 9/04

(52) U.S. Cl. CPC B60S 9/04

(57) ABSTRACT

Stabilizer systems and method for vehicles include arms configured to be positioned on sides of a vehicle. The arms have a first end configured to couple to a frame of the vehicle and a foot at a second end. A tensioning device is coupled to and extends between the feet. The tensioning device is configured to pull the feet together to stabilize the vehicle from vertical and side-to-side movement.

### CROSS-REFERENCE TO RELATED APPLICATION

This application claims the priority benefit of U.S. Provisional Application No. 63/698,303, filed Sep. 24, 2024, which is hereby incorporated by reference herein in its entirety.

### FIELD OF THE DISCLOSURE

The present disclosure generally relates to vehicle stabilization systems.

### BACKGROUND

Vehicles can have dual operating modes, driving and stationary use. Recreational Vehicles (RV) and utility type vehicles can be used much more in the stationary mode. Having a system to stabilize the vehicle during this mode can make their use much easier and more enjoyable for the occupants. Many RVs come with a leveling or jack system that will put the platform of the vehicle on a level plane and help with stabilizing the vertical movement of the vehicle, but they do not offer much help with stabilizing the sway of the vehicle. There are current systems that help with the sway, as well as help with the vertical movement if there is not a jack/leveling system, but they are attached to the vehicle in some manner permanently.

### BRIEF DESCRIPTION OF THE DRAWINGS

FIG. 1 is a perspective view of a first example stabilizer system for vehicles in accordance with the teachings of the present disclosure.

FIG. 2 is a front elevational view of the stabilizer system of FIG. 1.

FIG. 3 is a sectional view of a first example frame connection for the stabilizer system of FIG. 1.

FIG. 4 is a sectional view of a second example frame connection for the stabilizer system of FIG. 1.

FIG. 5 is a perspective view of a second example stabilizer system for vehicles in accordance with the teachings of the present disclosure.

FIG. 6 is a front elevational view of the stabilizer system of FIG. 5.

FIG. 7 is a sectional view of an example frame connection for the stabilizer system of FIG. 5.

FIG. 8 is a sectional view of the frame connection of FIG. 7.

FIG. 9 is a perspective view of a third example stabilizer system for vehicles in accordance with the teachings of the present disclosure.

FIG. 10 is a front elevational view of the stabilizer system of FIG. 9.

FIG. 11 is a side elevational view of the stabilizer system of FIG. 9.

### DETAILED DESCRIPTION

Stabilizer systems on vehicles are described herein. The stabilizer system attaches to the frame of the vehicle in a clip-on arrangement that can be easily attached and removed, with no permanent attachment necessary.

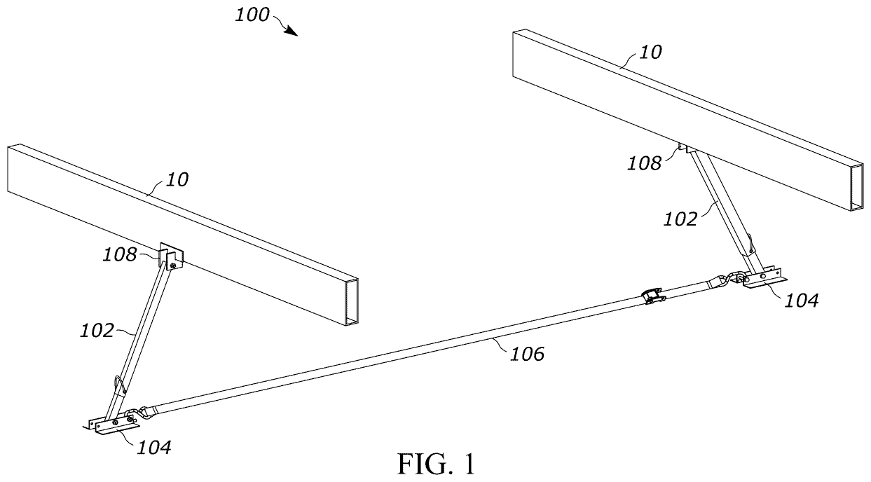

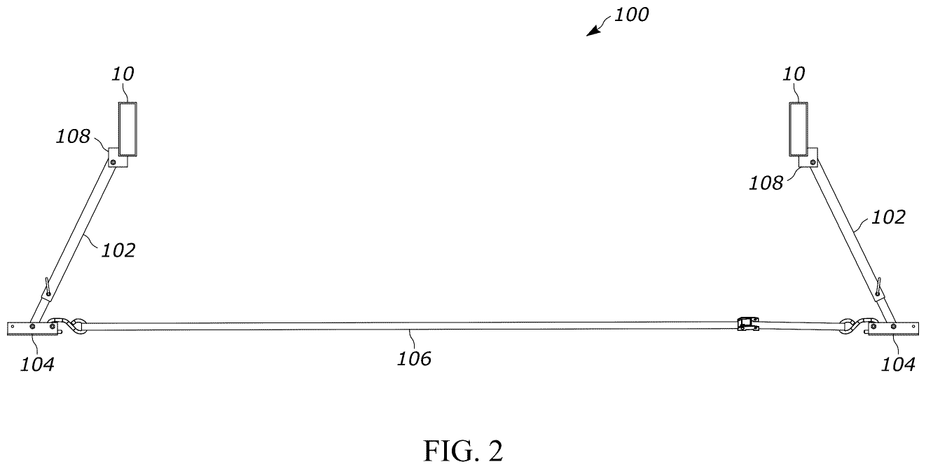

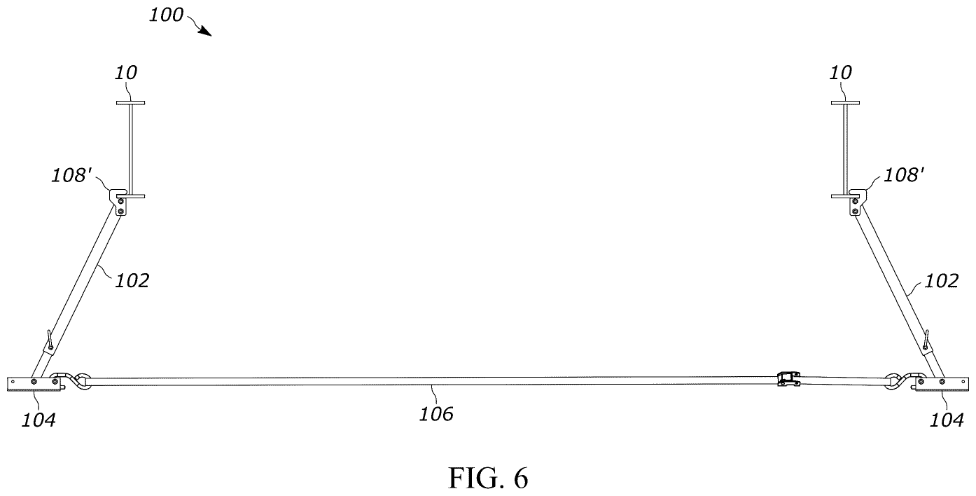

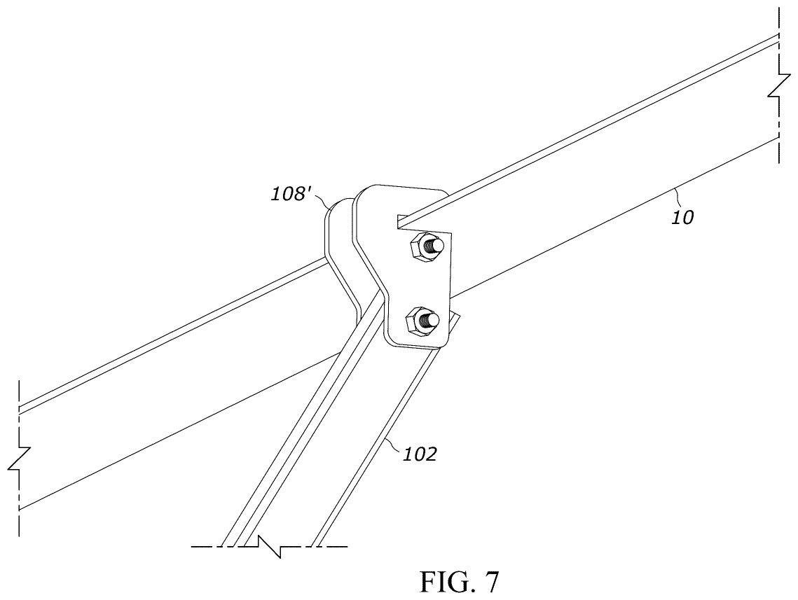

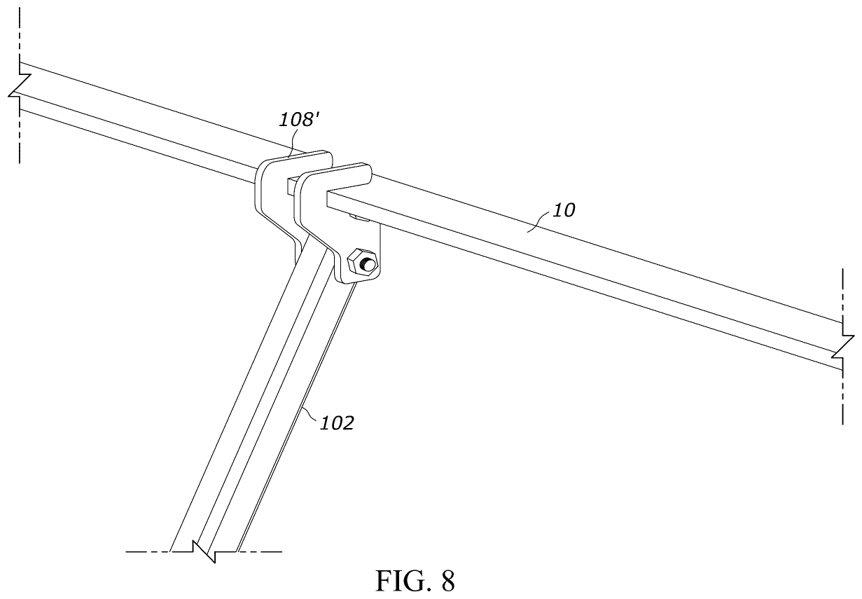

Example stabilizer systems 100 are shown in FIGS. 1-8. The stabilizer systems 100 include arms 102 that connect to a frame 10 of a vehicle on opposite sides thereof. The arms 102 can be adjustable to account for various ground conditions and vehicle heights. For example, the arms 102 can include telescoping sections, components that secure together with fasteners, clips, etc., pivoting sections, and so forth. Alternatively, the arms 102 can have a set length configured for a particular vehicle height and/or configuration.

The stabilizer system 100 works in pairs with each arm 102 of the stabilizer being attached on opposite sides of the frame 10, with the arms 102 extending laterally outwardly from the center of the frame 10 and relative to a longitudinal axis of the vehicle. The length of the arm 102 is set (e.g., adjusted), so that the angle of the arm 102 is at a desired angle. For example, the arms 102 can extend at close to a 45-degree angle to the ground. In other configurations, the angle can be between about 30 degrees to about 60 degrees.

The arms 102 of the stabilizer systems 100 further include feet 104 configured to engage a ground surface adjacent to the vehicle. The feet 104 can be integral with the main body of the arms 102 or can be coupled to (e.g., pivotably coupled) the main body of the arms 102. In some examples, the feet 104 extend laterally relative to the arms 102 and the longitudinal axis of the vehicle, e.g., perpendicular to the frame 10. Further, the feet 104 can include a base portion that extends along the longitudinal axis of the vehicle and relative to the arms 102 to provide added stability to the feet 104.

After the arms 102 are coupled to the frame 10 and positioned at a desired angle, the feet 104 are then connected together with a tensioning or tightening device or member 106. This tensioning device 106 can include a strap with a ratchet mechanism, a lashing mechanism, a turnbuckle, or any other type of device configured to apply a force pulling the feet 104 toward one another. When this tensioning device 106 is tightened, pulling the feet 104 of the two opposing stabilizer arms 102 together, it creates a force angled along each arm 102. This force has both a lifting component and an opposing side-to-side component. The vertical/lifting force stabilizes the frame 10 from vertical movement, and the horizontal/side-to-side force stabilizes the frame 10 from a side-to-side swaying motion. This stabilizer arrangement can be used with or without a leveling system and provides a benefit in both situations. This can be used on all types of vehicles, including cars, trucks, trailers, motorhomes, or other types of RVs that can benefit from stationary stabilization.

The tensioning device 106 can couple to the feet 104 by any suitable configuration. For example, one or both of the tensioning device 106 or feet 104 can include hooks to couple together. As shown, the tensioning device 106 includes hooks at the ends thereof that secure to bars or ridges of the feet 104. Other suitable structures include snap-fit connectors, fasteners, such as bolts, and so forth. Alternatively, the tensioning device 106 can include two portions that are permanently secured to the feet 104 (e.g., having a looped connection, fastened, etc.) and that releasably couple together.

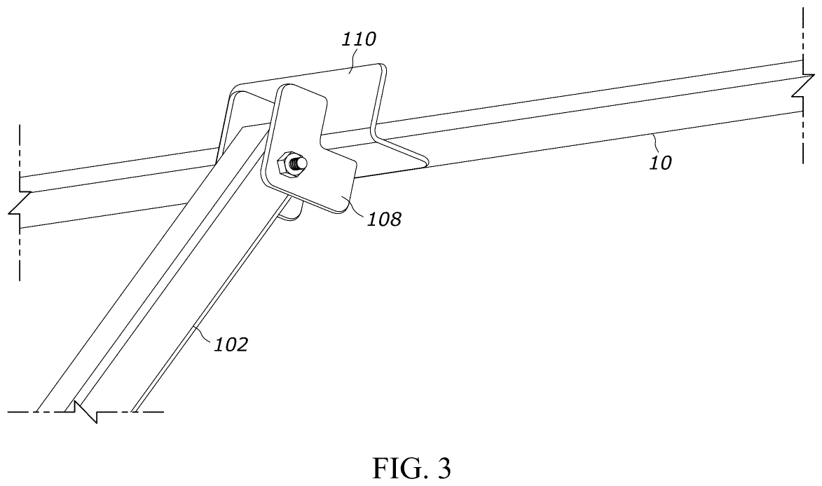

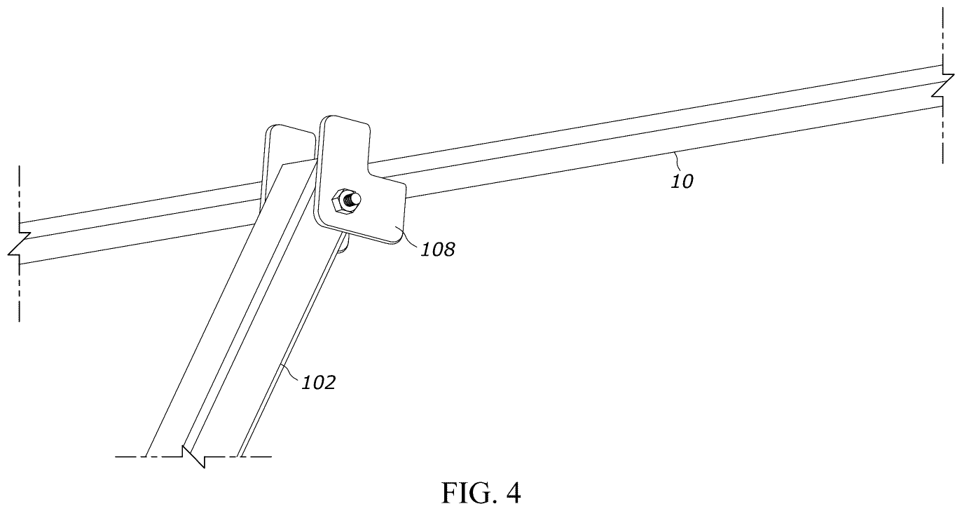

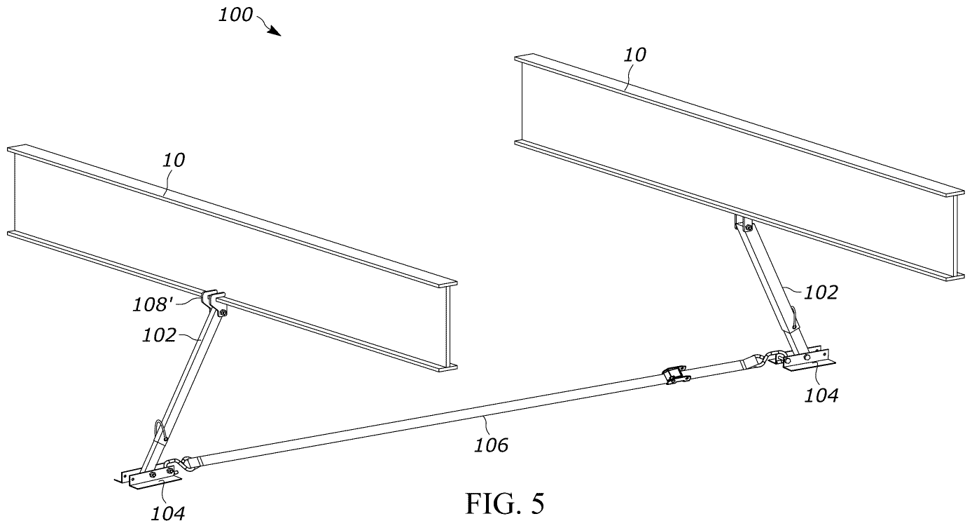

In some examples, the arms 102 include a clip 108, 108′ configured to couple to the frame 10 of the vehicle. As shown, the clip 108, 108′ is coupled to an end of a main body of the arm 102. The clip 108, 108′ can have any one of multiple suitable designs. In one example, as shown in FIGS. 1-5, the clip 108 can have a cradle or L-shaped configuration that is configured to engage a corner of the frame 10. For example, the clip 108 can extend along and engage the bottom and side of a rectangular tube or C channel style frame. The cradle can have many different suitable designs. For example, the cradle can include a long channel member 110 (FIG. 3) or simple brackets with an L-shaped cutout (FIG. 4) to nest along the frame 10. In another example, as shown in FIGS. 5-8, the clip 108′ can define a notch sized to clip over the bottom flange of an I beam or similar style frame (i.e., having the flange inserted therein). In any of the examples described herein, the clips 108, 108′ can be fixed relative to the main body of the arm 102 or can be pivotably coupled relative to the main body of the arm 102 to allow a user to adjust the orientation of the clip 108, 108′ during assembly.

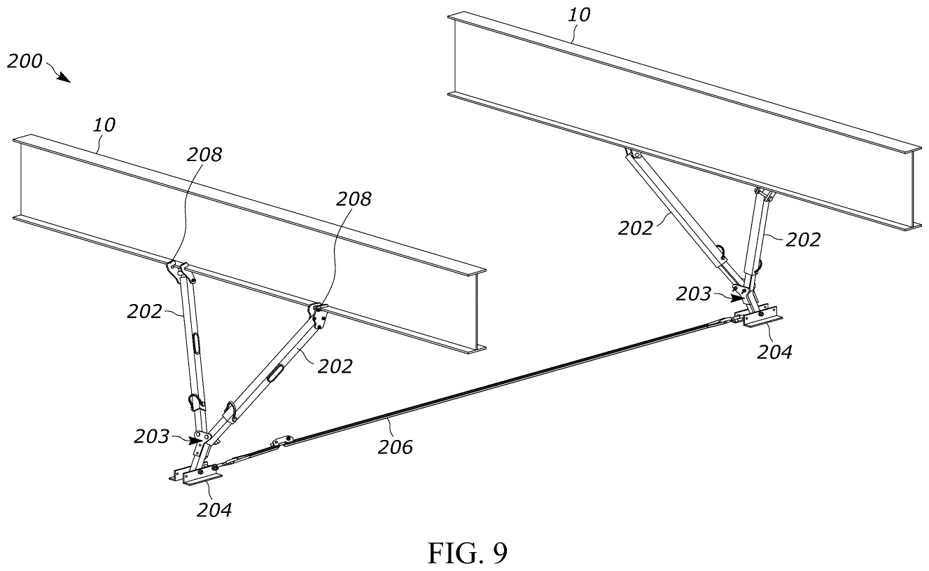

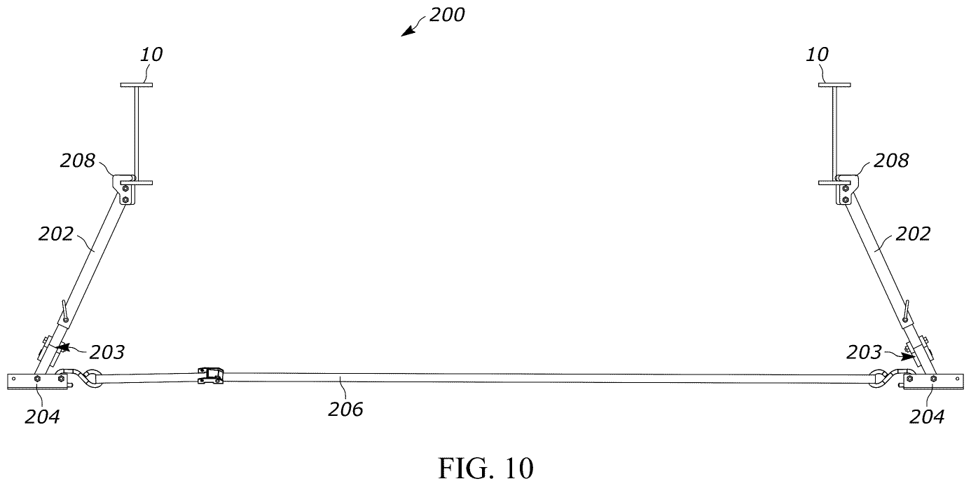

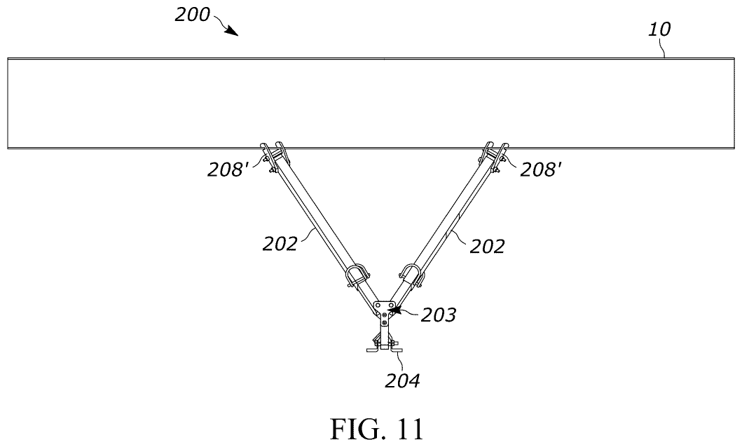

As shown in FIGS. 9-11, an alternative example stabilizer system 200 can include two arms 202 on each side of the frame 10. The arms 202 of each side both connect to a foot 204 at one end and spread apart in a V-shaped configuration to couple to the frame 10 at the opposite end. The arms 202 can both be pivotably coupled relative to the foot. For example, the system 200 can include a joint member 203 disposed between the arms 202 and the foot 204. In the illustrated form, the joint member 203 is a Y-connector with the arms 202 pivotably coupled at a top of the connector and a bottom bar extending to pivotably couple to the foot 204.

So configured, the arms 202 include one extending forwardly and one extending rearwardly of the foot 204 and relative to the longitudinal axis of the vehicle, such that the arms 202 are configured to engage the frame 10 in longitudinally spaced locations. The feet 204 are joined by a tensioning member or device 206, similar to that as described above. This stabilizer system 200 provides the same stabilization as the above-described example, but with the forward and aft split of the arms 202, the frame 10 is also stabilized for forward-and-backward motion. The arms 202 of this example can utilize clips 208 having any of the clip configurations described above, although configured to couple to the frame 10 with the arms 202 extending at longitudinal angles with respect to the frame 10.

The terms “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology. It will be appreciated that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments.

The same reference numbers may be used to describe like or similar parts. Further, while several examples have been disclosed herein, any features from any examples may be combined with or replaced by other features from other examples. Moreover, while several examples have been disclosed herein, changes may be made to the disclosed examples without departing from the scope of the claims. Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A stabilizer system for a vehicle, the stabilizer system comprising:
a pair of arms configured to be positioned on lateral sides of a vehicle, the arms each including a clip configured to couple to a frame of the vehicle at one end and a foot at an opposite end; and
a tensioning device coupled to and extending between the feet, the tensioning device configured to pull the feet together to stabilize the vehicle from vertical and side-to-side movement.

2. The stabilizer system of claim 1, wherein the arms are adjustable to change a length thereof.

3. The stabilizer system of claim 1, wherein the tensioning device comprises a ratchet strap.

4. The stabilizer system of claim 1, wherein the feet are pivotably coupled relative to a main body of the arms.

5. The stabilizer system of claim 1, wherein the feet are integral with a main body of the arms.

6. The stabilizer system of claim 1, wherein the clips have a cradle or L-shaped configuration to engage a corner of the frame of the vehicle.

7. The stabilizer system of claim 6, wherein the clips include a channel member having an L-shaped configuration.

8. The stabilizer system of claim 6, wherein the clips include opposing brackets having an L-shaped cutout.

9. The stabilizer system of claim 1, wherein the clips define a notch sized to receive a flange of the frame.

10. The stabilizer system of claim 1, wherein the arms each comprise two arms coupled together in a V-shaped configuration.

11. The stabilizer system of claim 1, wherein clips are pivotably coupled to a main body of the arms.

12. A method for stabilizing a vehicle, the method comprising:
coupling arms of a stabilizer system to opposite sides of a frame of a vehicle by engaging the frame with clips disposed at one end of the arms;
coupling a tensioning device between feet at an opposite end of the arms;
tightening the tensioning device to pull the feet towards one another and create a force angled along the arms into the frame to stabilize the frame against vertical movement and from a side-to-side swaying motion.

13. The method of claim 12, further comprising adjusting a length of the arms to position the arms at a desired angle relative to the frame.

14. The method of claim 12, wherein tightening the tensioning device comprises ratcheting a ratchet mechanism of the tensioning device.

15. The method of claim 12, further comprising pivoting the feet relative to a main body of the arm to engage a ground surface adjacent to the vehicle.

16. The method of claim 12, wherein coupling the arms to the frame comprises engaging a corner of the frame with a clip having a cradle or L-shaped configuration.

17. The method of claim 12, wherein the coupling the arms to the frame comprises inserting flanges of the frame into notches defined by the clips.

18. The method of claim 12, wherein coupling the arms to the frame comprises coupling arms disposed in a V-shaped configuration to the opposite sides of the frame to engage the opposite sides of the frame in longitudinally spaced locations.

19. The method of claim 12, wherein engaging the frame with the clips comprises pivotably adjusting the clips relative to a main body of the arms.
